(19) United States
(12) Patent Application Publication
(10) Pub. No.: US 2019/0222080 A1
(43) Pub. Date: Jul. 18, 2019

(54) STATOR FOR ROTARY ELECTRIC MACHINE, ROTARY ELECTRIC MACHINE, AND ROTARY ELECTRIC MACHINE UNIT

(71) Applicant: HONDA MOTOR CO., LTD., Tokyo (JP)

(72) Inventors: Keisuke AZUSAWA, Wako-shi (JP); Ryotaro KANEKO, Wako-shi (JP)

(21) Appl. No.: 16/249,151

(22) Filed: Jan. 16, 2019

(30) Foreign Application Priority Data
Jan. 18, 2018 (JP) 2018-006216

(51) Int. Cl. H02K 3/30; H02K 1/16; H02K 3/12; H02K 3/34; H02K 5/20; H02K 7/00; H02K 9/19

(52) U.S. Cl. CPC H02K 3/30; H02K 1/16; H02K 3/12; H02K 9/19; H02K 5/20; H02K 7/006; H02K 3/34

(57) ABSTRACT

A stator for a rotary electric machine gives higher visibility to foreign matter attached to a surface of an insulating film. The stator includes: a stator core that has multiple slots; and a stator coil that is wound around the stator core via the slots, wherein the stator coil includes multiple coil segment groups that are coupled with each other, and each of the coil segment groups has at least two rectangular wires, each having a porous film as an insulating member, wherein at least two of the rectangular wires have corresponding surfaces, facing perpendicular to a row direction thereof, arranged parallel to one another, and the porous film is formed to have pores in an insulating material with a porosity ratio of 17% or more but no more than 35%.

### CROSS-REFERENCE TO RELATED APPLICATION

This application claims the benefit of priority to Japanese Patent Application No. 2018-006216 filed 18 Jan. 2018, the disclosures of all of which are hereby incorporated by reference in their entireties.

### TECHNICAL FIELD

The present invention relates to a stator for a rotary electric machine, a rotary electric machine, and a rotary electric machine unit.

### BACKGROUND OF THE INVENTION

Japanese Patent Application Publication No. H05-20928 A (hereinbelow, referred to as Patent Document 1) and Japanese Patent Application Publication No, H08-77849 A (hereinbelow, referred to as Patent Document 2) each disclose a technique of using a foamed insulator as an insulating film of an electric wire. In addition, Japanese Patent Application Publication No. 2014-225974 A (hereinbelow, referred to as Patent Document 3) discloses a stator for a segment-conductor rotary electric machine and a manufacturing method of the same.

### SUMMARY OF THE INVENTION

### Problems to be Solved

However, none of above-cited Patent Documents 1 to 3 particularly describes giving higher visibility to foreign matter attached to the surface of an insulating film. The present invention has been made in view of the foregoing background and is intended to provide a stator for a rotary electric machine, a rotary electric machine, and a rotary electric machine unit which give higher visibility to foreign matter attached to the surface of an insulation film.

### Solution to Problem

In order to solve the aforementioned problems, a stator for a rotary electric machine of the present invention includes: a stator core that has multiple slots; and a stator coil that is wound around the stator core via the slots, wherein the stator coil includes multiple coil segment groups that are coupled with each other and each have multiple rectangular wires having a porous film as an insulating member, wherein at least two of the rectangular wires have corresponding surfaces, facing perpendicular to a row direction thereof, arranged parallel to one another, and the porous film is formed to have pores in an insulating material with a porosity ratio of 17% or more but no more than 35%.

### Advantageous Effects of the Invention

The present invention gives higher visibility to foreign matter attached to the surface of an insulating film.

### BRIEF DESCRIPTION OF DRAWINGS

FIG. 1 is a schematic diagram of an electric vehicle having one or more components according to an embodiment of the present invention;

FIG. 2 is a front view of a stator according to the embodiment;

FIG. 3 is a perspective view of a coil segment group of the embodiment;

FIG. 4 is a side view of the coil segment group of the embodiment;

FIG. 5 is a cross-sectional view of the coil segment group of the embodiment;

FIG. 6 is a chart of characteristics to a porosity ratio of a porous film of the embodiment;

FIG. 7 is a cross-sectional view of a coil segment group of a comparative example;

FIG. 8 is a cross-sectional view of a coil segment group of a modification; and

FIG. 9 is a perspective view of coil segment groups of another modification.

### EMBODIMENTS OF THE INVENTION

### Configuration of Embodiment

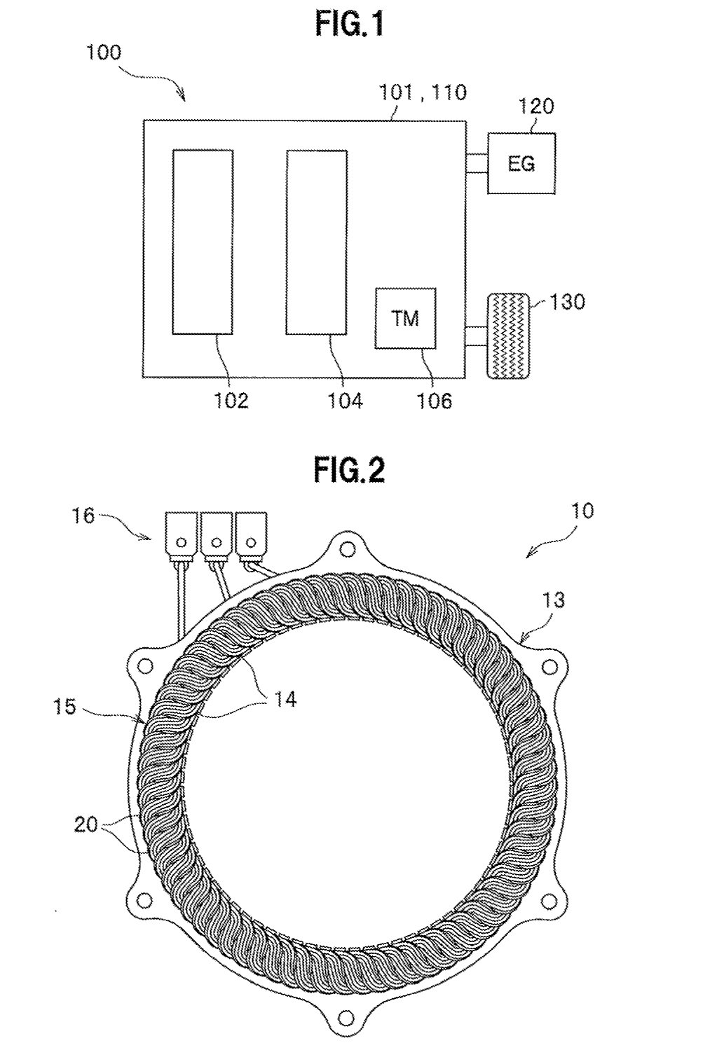

FIG. 1 is a schematic diagram of an electric vehicle 100 having one or more components according to an embodiment of the present invention. The electric vehicle 100 includes an engine 120, a rotary electric machine unit 110, and a wheel 130. Here, the rotary electric machine unit 110 includes rotary electric machines 102, 104, a transmission 106, and a housing 101 that houses preceding components. A shaft (no reference numeral assigned) of the engine 120 and the wheel 130 is coupled to the rotary electric machine unit 110. Then, the wheel 130 is rotationally driven by the rotary electric machines 102, 104 or the engine 120.

The housing 101 has therein unshown ATF (automatic transmission fluid) or lubricating oil circulated. The ATF lubricates respective parts of the transmission 106 and is also used as a refrigerant for the rotary electric machines 102, 104. As the ATF lubricates the transmission 106, foreign matter (also referred to as contamination) such as metal scraps is likely to be mixed into the ATF. The rotary electric machines 102, 104, if foreign matter of this kind is attached to coils or the like thereof, may have an insulation failure. Therefore, foreign matter attached to the coils or the like is desired to be suitably detected and removed at the time of manufacturing and maintaining the electric vehicle 100.

FIG. 2 is a front view of a stator 10 (stator for rotary electric machine) included in the rotary electric machines 102, 104. The stator 10 includes a stator core 13 formed in a substantially cylindrical shape. The stator core 13 is formed, on its inner peripheral wall, with multiple slots 14, penetrating in the axial direction, at predetermined intervals in the circumferential direction. The slots 14 have stator coils 15 in multiple phases (e.g., U-phase, V-phase, W-phase) wound therearound. The stator coils 15 are connected to power supply terminals 16 so that electric power is supplied from an external power supply. A rotor, not shown, is rotatably arranged inside the stator 10. The stator coils 15 are formed to have multiple coil segment groups 20 coupled with each other by welding or the like.

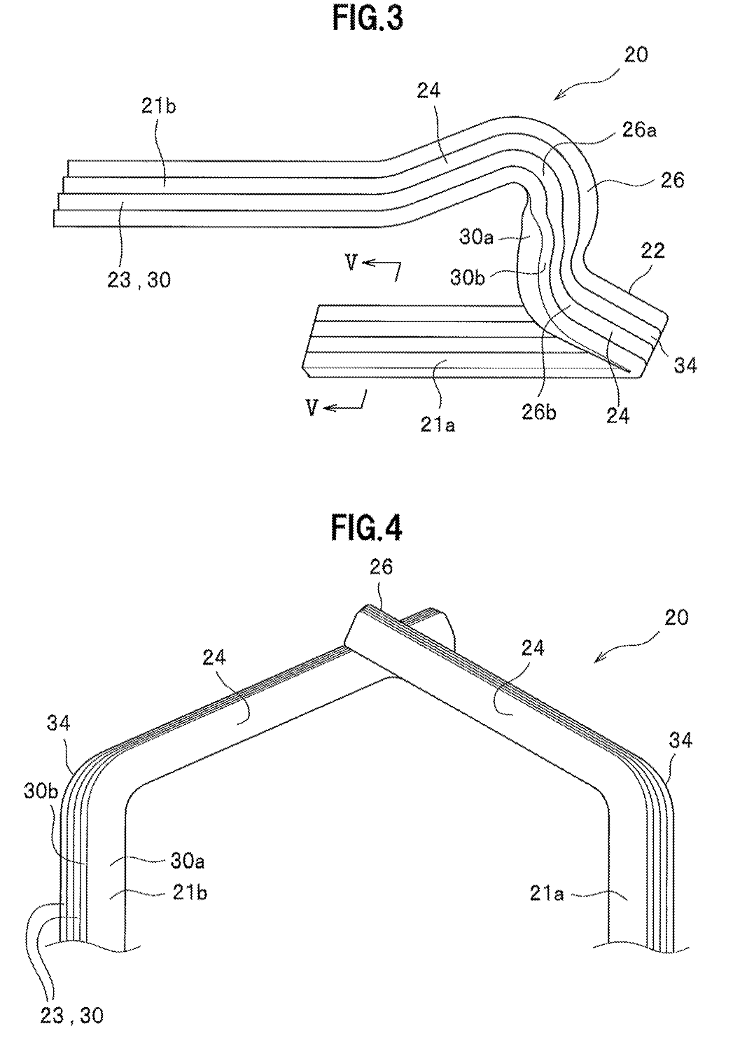

FIG. 3 is a perspective view of the coil segment group 20 of the present embodiment, and FIG. 4 is a side view of the coil segment group 20. In FIG. 3, the coil segment group 20 includes a pair of leg portions 21a, 21b extending in parallel to each other, and a connecting portion 22 connecting the leg portions 21a, 21b with each other at one end thereof, so as to form a substantially U-shape. In addition, the coil segment group 20 is formed to have multiple (four, in the drawing) coil segments 23 arranged in a row and bundled. Here, the coil segment 23 is formed to have a rectangular wire 30, having a substantially rectangular cross section, bent into a substantially U-shape.

The rectangular wire 30 has a cross-section in a substantially rectangular shape, and then the rectangular wire 30 has a pair of wide-width lateral surfaces 30a, facing each other, and a pair of narrow-width lateral surfaces 30b, facing each other and each having a width narrower than that of the wide-width lateral surface 30a. The coil segments 23 are arranged in a row so that the adjacent wide-width lateral surfaces 30a abut each other. In addition, the abutting surfaces of the leg portions 21a, 21b are the same as those of the connecting portion 22. The connecting portion 22 is formed, in the center thereof, with a curved portion 26 that is curved in a substantially S-shape. The curved portion 26 has at least two curved spots 26a, 26b where the connecting portion 22 is alternately curved toward an opposite direction to each other.

Further, the curved portion 26 is formed with a pair of inclined portions 24, as shown in FIG. 4, that are inclined with respect to the horizontal direction when the leg portions 21a, 21b are oriented in the vertical direction. The pair of inclined portions 24 respectively connects to the leg portions 21a, 21b to form bent portions 34 at connection points therebetween. At the bent portion 34, the narrow-width lateral surfaces 30b of the coil segments 23 collectively form an inner curved surface and an outer curved surface of the coil segment group 20, as shown in the drawing. Note that the detailed shape, manufacturing method, and the like of the coil segment group 20 in FIGS. 3 and 4 are the same as those in Patent Document 3 cited above. The coil segment groups 20 configured as above are inserted into the slots 14 (see FIG. 2) and then open ends of the coil segment groups 20 are coupled with each other by welding or the like, to form the stator coils 15.

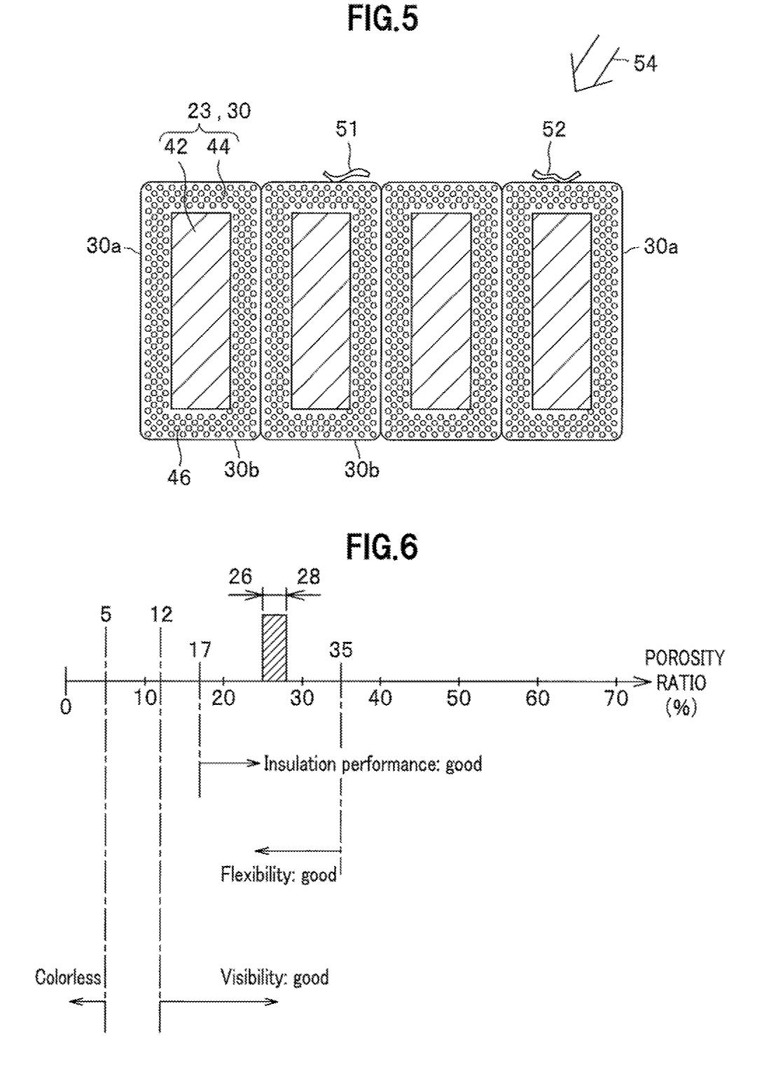

FIG. 5 is a cross-sectional view taken along a line V-V in FIG. 3. As shown in the drawing, the coil segment 23 or the rectangular wire 30 includes a conductor 42 that has a substantially rectangular cross section and is mainly composed of copper, and a porous film 44 that surrounds the outer periphery of the conductor 42 and is an insulator having a cross section in a substantially rectangular frame shape. The porous film 44 is formed to have pores 46 in an insulating material. Note that the pores 46 may be closed pores or open pores. Additionally, FIG. 5 shows foreign matter 51, 52, attached to the porous film 44, and incident light 54 for a worker to detect the foreign matter 51, 52.

An insulating material used for the porous film 44 can be polyesterimide, THEIC (Tris-2-Hydroxyethyl Isocyanurate) modified polyesterimide, polyamide-imide, polyimide, or the like, for example. In addition, the pore 46 is filled with hydrocarbons such as petroleum ether, isobutane, heptane, and hexane, low-boiling halogenated hydrocarbons such as monochlorotrifluoromethane, dichlorodifluoromethane, trichlorotrifluoroethane, and dichlorotetrafluoroethane, methylsilane, or the like, for example. Further, a chemical foaming agent such as an azo foaming agent, a semicarbazide foaming agent, and a nitroso foaming agent may be used to form the pores 46. The thickness of the porous film 44 varies depending on a required pressure resistance characteristic, but is preferably set to 20 to 120 μm, for example. The ratio of the pores 46 to the total volume of the porous film 44 is referred to as a “porosity ratio.”

Here, the characteristics with respect to the porosity ratio of the porous film 44 are shown in FIG. 6. Note that it is assumed in FIG. 6 that the thickness of the porous film 44 is about 40 to 50 μm. When the porosity ratio is less than 5%, the porous film 44 seems almost colorless with the naked eye. If the porous film 44 seems colorless, the foreign matter 51, 52 will be less likely detected with the naked eye due to the ground color of the conductor 42 (see FIG. 5). When the porosity ratio is 5% or more, the porous film 44 seemingly becomes slightly yellow. However, when the porosity ratio is 5% or more but less than 12%, the transparency level is still high so that the foreign matter 51, 52 is less likely detected. In contrast, when the porosity ratio is 12% or more, the transparency level is sufficiently low so that the foreign matter 51, 52 is easily detected with the naked eye. As described above, the porosity ratio of the porous film 44 is preferably set to 12% or more in order to facilitate detection of foreign matter.

In addition, when stress such as bending stress is applied to the porous film 44, the pores 46 may cause the porous film 44 to be torn. Therefore, the smaller the porosity ratio is, the more flexibility the porous film 44 has, making it less likely torn. As described above, at the bent portion 34 (see FIG. 4), the narrow-width lateral surfaces 30b of the coil segments 23 collectively form the inner and outer curved surfaces of the coil segment 20. In order to have good flexibility in consideration of such bending, the porosity ratio of the porous film 44 is preferably set to 35% or less.

Further, as the pore 46 has a low dielectric constant, the higher the porosity ratio is, the higher the insulation performance of the porous film 44 is. Assuming that the thickness of the porous film 44 is about 40 to 50 μm and a voltage of about 300 V modulated by PWM (Pulse Width Modulation) is applied to the conductor 42, setting the porosity ratio of the porous film 44 to 17% or more gives good insulation performance.

As described above, the porosity ratio of the porous film 44 is preferably set to 17% or more but no more than 35%, to make all of the visibility of the foreign matter 51, 52, insulation performance, and flexibility desireable. In particular, setting the porosity ratio to about 26 to 28%, as indicated by hatching in the drawing, gives sufficiently large margins to all of the visibility, insulation performance, and flexibility. Therefore, it is more preferable at the time of manufacturing the rectangular wire 30 to set the target value of the porosity ratio of the porous film 44 to about 27% and then to control a margin of error of plus or minus about 1%.

### Comparative Example

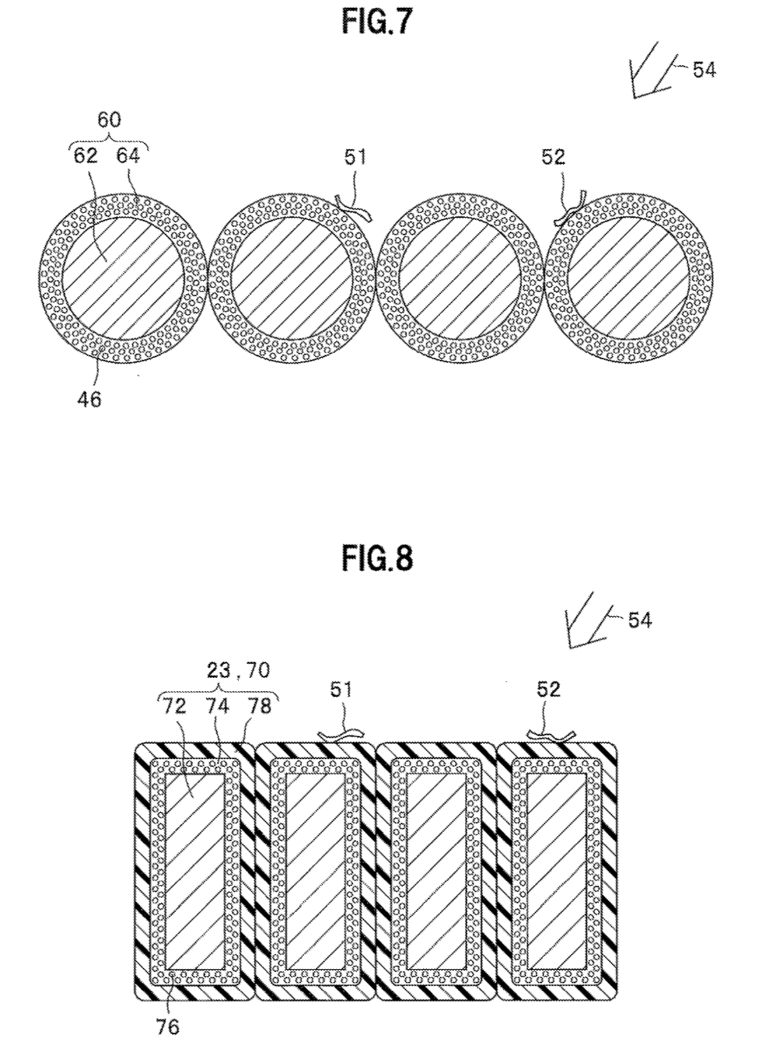

Next, a description will be given of the configuration of a comparative example to clarify advantageous effects of the present embodiment. FIG. 7 is a cross-sectional view of a coil segment group according to the comparative example. This comparative example uses a round wire 60 in place of the rectangular wire 30 in the foregoing embodiment. The round wire 60 has a conductor 62 having a circular cross section and a porous film 64 covering the conductor 62. Note that materials of the conductor 62 and porous film 64 are respectively the same as those of the conductor 42 and porous film 44 in the foregoing embodiment (see FIG. 5).

In the comparative example, the foreign matter 51, 52 may not be easily detected, depending on the angle of the incident light 54. Even if one of these is detected, the other of these may not be detected. Then, one must observe the porous film 64 by changing the angle of the incident light 54 variously to detect foreign matter attached to the porous film 64, and this complicates the work.

### Advantageous Effects of Embodiment

As described above, the rotary electric machine unit 110 of the present embodiment includes: the housing 101 that has lubricating oil circulated therein; the rotary electric machine 102 or 104 that is housed in the housing 101 and includes the stator 10 including the stator core 13 that is formed in a substantially cylindrical shape and has the multiple slots 14 on its inner peripheral wall and the stator coil 15 that is wound around the stator core 13 via the slots 14, and the rotor that is arranged to face the inner peripheral wall of the stator core 13 so as to be rotatable with respect to the stator 10; and the transmission 106 that is housed in the housing 101 and is driven by the rotary electric machine 102 or 104 to drive the wheel 130, wherein the stator coil 15 includes the multiple coil segment groups 20 that are coupled with each other and each have at least two rectangular wires 30, having the porous film 44 as an insulating member, bent together, and the porous film 44 is formed to have the pores 46 in an insulating material with the porosity ratio of 17% or more but no more than 35%.

With the porosity ratio of the insulating material set to 17% or more but no more than 35%, the present embodiment allows the stator to have higher insulation performance and higher flexibility, and to give higher visibility to foreign matter attached to the porous film 44 so that working performance is improved in manufacturing and maintaining the electric vehicle 100. Particularly, in the rotary electric machine unit 110 housing the rotary electric machines 102, 104 and the transmission 106 in the same housing 101, foreign matter generated such as from the transmission 106 will accurately be detected.

Additionally, in the present embodiment, the rectangular wire 30 has the pair of wide-width lateral surfaces 30a, facing each other, and the pair of narrow-width lateral surfaces 30b, facing each other and each having a width narrower than that of the wide-width lateral surface, and the coil segment group 20 is formed to have the four rectangular wires 30 abutted each other on the wide-width lateral surfaces thereof and bent so that the narrow-width lateral surfaces collectively form the inner and outer curved surfaces thereof.

This allows one to observe the wide-width lateral surfaces 30a and narrow-width lateral surfaces 30b of the four rectangular wires 30 at a time, to give further visibility to foreign matter attached to the porous film 44. In addition, using the rectangular wire 30 increases the volume fraction of the conductor 42 in the space where the rectangular wires 30 are wired, to allow the rotary electric machines 102, 104 to be reduced in size.

### Modifications

The present invention is not limited to the foregoing embodiment, and may have various modifications. The foregoing embodiment has been described for the purpose of illustrating the present invention, and is not necessarily limited to the one having all the components as described above. Additionary, the configuration of the foregoing embodiment may be added with another configuration, and/or may partly be replaced with another configuration. The following are examples of possible modifications to the foregoing embodiment.

1) In the foregoing embodiment, an insulator having a multilayer structure may be used in place of the porous film 44. An example is shown in FIG. 8. Note that FIG. 8 is a cross-sectional view of a coil segment group according to the present modification. In this modification, a rectangular wire 70 is used in place of the rectangular wire 30 in the foregoing embodiment (see FIG. 5). The rectangular wire 70 has a conductor 72, a porous film 74 surrounding the outer periphery of the conductor 72, and a film 78 surrounding the outer periphery of the porous film 74.

The conductor 72 is configured similarly to the conductor 42 in the foregoing embodiment (see FIG. 5). In addition, the porous film 74 is formed to have pores 76 in an insulating material, as with the porous film 44 of the foregoing embodiment. Further, the film 78 is formed of a normal insulating film and may not have the pores 46. As described above, the rectangular wire 70 of the present modification adopts a double insulation structure to minimize a leakage current to the outside even if the porous film 74 is damaged for some reason.

2) In the foregoing embodiment, the coil segment group 20 is formed to have the four coil segments 23 or the four rectangular wires 30 abutted against each other, but the number of the coil segments 23 included in one coil segment group 20 is not limited to “4” and may be “2” or more.

3) In the foregoing embodiment, the narrow-width lateral surfaces 30b of the four coil segments 23 forming the coil segment group 20 are aligned so as to be flush with each other, as shown in FIG. 5. However, these narrow-width lateral surfaces 30b are not always required to be all aligned so as to be flush with each other. That is, each coil segment group may “include multiple rectangular wires, each having a porous film as an insulating member and at least two of them having corresponding surfaces, facing perpendicular to a row direction thereof, arranged parallel to one another.”

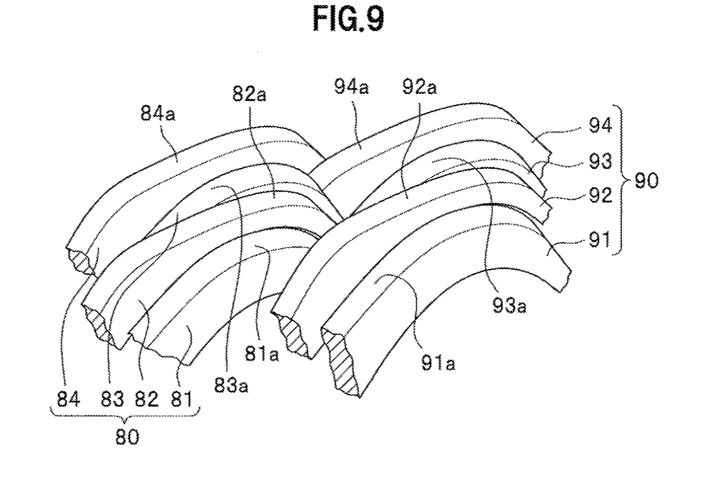

FIG. 9 is a perspective view of coil segment groups according to a modification as an example. In FIG. 9, a coil segment group 80 includes rectangular wires 81, 82, 83, 84, wherein narrow-width lateral surfaces 81a, 83a of the rectangular wires 81, 83 are parallel to each other. Narrow-width lateral surfaces 82a, 84a of the rectangular wires 82, 84 are also parallel to each other. Similarly, a coil segment group 90 includes rectangular wires 91, 92, 93, 94, wherein narrow-width lateral surfaces 91a, 93a of the rectangular wires 91, 93 are parallel to each other. Narrow-width lateral surfaces 92a, 94a of the rectangular wires 92, 94 are also parallel to each other.

These rectangular wires 81 to 84, 91 to 94 each have the same structure as the rectangular wire 30 (see FIG. 5) of the foregoing embodiment. Additionally, one or more of the rectangular wires 81 to 84 are interposed, individually or collectively, between appropriate ones of the rectangular wires 91 to 94. The configuration of this modification also allows foreign matter (not shown) attached to the narrow-width lateral surfaces 81a, 83a, for example, to be detected at the same incident angle of incident light. Of course, the same advantageous effects are obtained even when three specific lateral surfaces of the coil segment group are parallel to one another.

What is claimed is:

1. A stator for a rotary electric machine, comprising:
a stator core that has multiple slots; and
a stator coil that is wound around the stator core via the slots,
wherein the stator coil includes multiple coil segment groups that are coupled with each other and each have multiple rectangular wires having a porous film as an insulating member, wherein at least two of the rectangular wires have corresponding surfaces, facing perpendicular to a row direction thereof, arranged parallel to one another, and
the porous film is formed to have pores in an insulating material with a porosity ratio of 17% or more but no more than 35%.

2. A stator for a rotary electric machine, comprising:
a stator core that has multiple slots; and
a stator coil that is wound around the stator core via the slots,
wherein the stator coil includes multiple coil segment groups that are coupled with each other and each have at least two rectangular wires, having a porous film as an insulating member, bent together, and
the porous film is formed to have pores in an insulating material with a porosity ratio of 17% or more but no more than 35%.

3. The stator for a rotary electric machine as claimed in claim 2, wherein
the rectangular wire has a pair of wide-width lateral surfaces, facing each other, and a pair of narrow-width lateral surfaces, facing each other and each having a width narrower than that of the wide-width lateral surface, and
the coil segment group is formed to have the four rectangular wires abutted each other on the wide-width lateral surfaces thereof and bent so that the narrow-width lateral surfaces collectively form an inner curved surface and an outer curved surface thereof.

4. A rotary electric machine comprising:
a stator as claimed in claim 1, wherein the stator core is formed in a substantially cylindrical shape and has the multiple slots on its inner peripheral wall, and
a rotor that is arranged to face the inner peripheral wall of the stator core so as to be rotatable with respect to the stator.

5. A rotary electric machine comprising:
a stator as claimed in claim 2, wherein the stator core is formed in a substantially cylindrical shape and has the multiple slots on its inner peripheral wall, and
a rotor that is arranged to face the inner peripheral wall of the stator core so as to be rotatable with respect to the stator.

6. A rotary electric machine unit comprising:
a housing that has lubricating oil circulated therein;
a rotary electric machine as claimed in claim 4, wherein the rotary electric machine is housed in the housing; and
a transmission that is housed in the housing and is driven by the rotary electric machine to drive a wheel.

7. A rotary electric machine unit comprising:
a housing that has lubricating oil circulated therein;
a rotary electric machine as claimed in claim 5, wherein the rotary electric machine is housed in the housing; and
a transmission that is housed in the housing and is driven by the rotary electric machine to drive a wheel.
